(19) United States
(12) Patent Application Publication
(10) Pub. No.: US 2003/0100217 A1
(43) Pub. Date: May 29, 2003

(54) Connector casing structure having light-guiding property

(76) Inventor: Lee-Jen Wu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/993,691

(22) Filed: Nov. 27, 2001

(51) Int. Cl. H01R 3/00

(52) U.S. Cl. 439/490

(57) ABSTRACT

A light-guiding connector casing structure includes an internal casing that is enclosed within an external casing to prevent electromagnetic interference. The internal casing is comprised of left and right half bodies that are fabricated from light-guiding material and assemble with each other. A face of the internal casing is transparent while other faces are opaque. Within upper and lower halves of the internal casing are respectively defined upper and lower placement spaces where a signal connector and a USB connector are respectively mounted. A mounting space proximate to a rear side of the internal casing receives front and rear guiding blocks. Two sides of the rear guiding block have guiding slots where connecting wires of light-emitting elements and positioning bars of the left and right half bodies insert. Protruding wires pass through the front guiding block and a plate of the rear guiding block to connect the signal connector.

### BACKGROUND OF THE INVENTION

1. Field of the Invention

The invention relates to a connector casing structure having light-guiding characteristic. More particularly, the invention provides a casing structure with light-guiding property that guides the light emitted from an internal light-emitting element to a front face pervious to light.

2. Description of the Related Art

Within telecommunication appliances that are equipped with a RJ-type connector, a pair of indicator lamps are conventionally mounted into the connector to indicate whether the signal configurations are in normal state. The indicator lamps are conventionally red and green indicator lamps that show whether the connection is normal or not established. Such an installation is conventionally achieved via light-emitting diodes, and may be used to indicate, for example, the state of internet connection.

Referring to FIG. 1, a perspective and exploded view schematically shows a conventional connector casing structure. The conventional connector casing structure comprises an internal casing 11 and an external casing 12. The internal casing 11, conventionally fabricated in a single body, includes a placement space 13 within an upper portion to receive a signal connector 2 while a placement space 14 is defined within a lower portion to receive a Universal Serial Bus (USB) connector 3. Because the signal connector 2 is positioned higher within the casing structure, terminal contacts 21 are also located at a higher level. As a result, a guiding plate 22 must be specifically designed and positioned to connect the terminal contacts 21 to a circuit board 20 located at a lower level. Furthermore, the indicator lamps 15, 16 are conventionally light-emitting diodes that are enclosed within a L-shaped guiding case 17. The arrangement of a L-shaped slot 18 on one side of the external casing 11 must be necessary to fit the case 17 with the indicator lamps 15, 16 into the casing structure. Such a design is cumbersome and not economical.

### SUMMARY OF THE INVENTION

It is therefore a principal object of the invention to provide a connector casing structure having light-guiding property that is easily fabricated and does not necessitate specific designs to accommodate the light-emitting elements and the connectors within the casing structure.

It is another object of the invention to provide a connector casing structure having light-guiding property that can accommodate one or two connectors of different types and, more particularly, connector types that need the arrangement of indicator lamps.

In accordance with the above and other objectives, a connector casing structure having light-guiding property of the invention comprises an internal casing and an external casing. The external casing encloses the internal casing to prevent electromagnetic interference. The internal casing is comprised of left and right half bodies that fixedly assemble with each other, the left and right half bodies being made of light-guiding material. The internal casing has a front face that is smooth and transparent while other remaining faces of the internal casing are opaque. Within an upper half of the internal casing is defined an upper placement space in which a signal connector is mounted. Within a lower half of the internal casing is defined a lower placement space in which a stacked-type Universal Serial Bus (USB) connector is mounted. A mounting space is defined within the internal casing proximate to a rear side thereof to receive a guiding block composed of a front guiding block and a rear guiding block. Two sides of the rear guiding block are respectively provided with a guiding slot through which connecting wires of a light-emitting element insert. The left and right half bodies internally bend into left and right bars that are vis-a-vis positioned and fit into the guiding slots of the rear guiding block to fixedly position the rear guiding block. A plate provided with two rows of through holes further extends forwardly from the rear guiding block. A plurality of protruding wires passing through the front guiding block extend upwardly to connect the signal connector and downwardly through the through holes of the plate of the rear guiding block to connect a circuit board.

With the connector casing structure hence arranged, lights emitted from the light-emitting elements are guided through the internal casing to its front face to indicate whether the connection state is normal.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective and exploded view of a conventional connector casing structure;

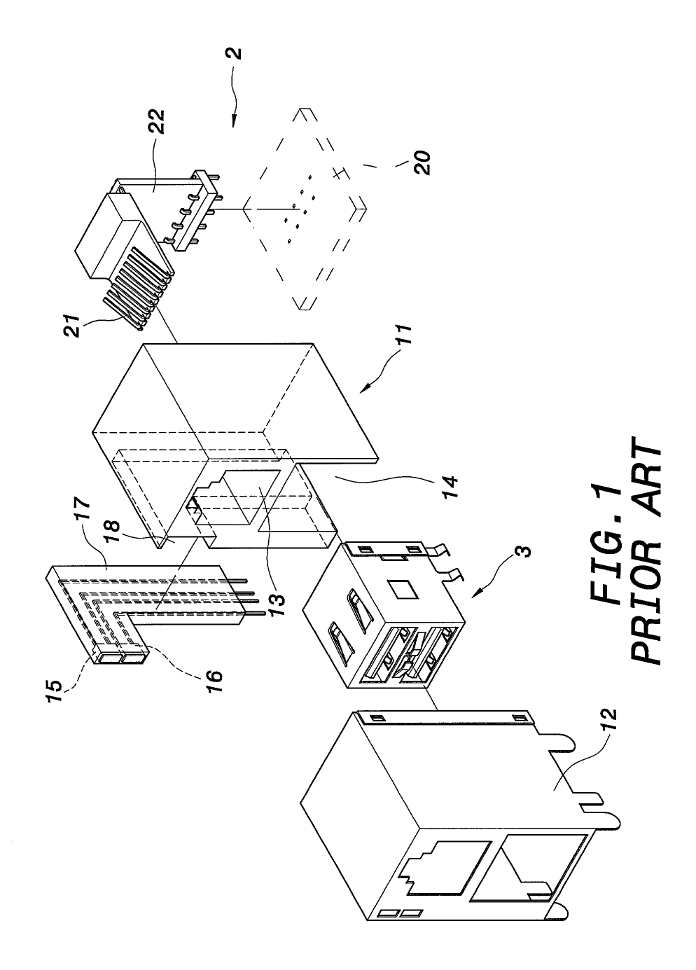

FIG. 2 is a perspective view of a connector casing structure having light-guiding property according to an embodiment of the invention;

FIG. 3 is a perspective and exploded view of a connector casing structure having light-guiding property according to an embodiment of the invention;

FIG. 4 is a perspective and exploded view of the connector casing structure of FIG. 3 rotated an angle of 90 degrees; and

FIG. 5 is a perspective view showing a rear side of the connector casing structure of the invention without the right half body.

### DETAILED DESCRIPTION OF THE EMBODIMENTS

Wherever possible in the following description, like reference numerals will refer to like elements and parts unless otherwise illustrated.

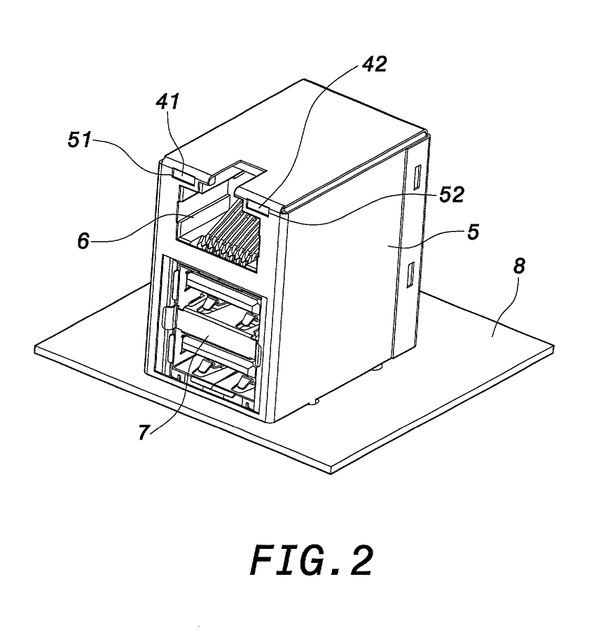

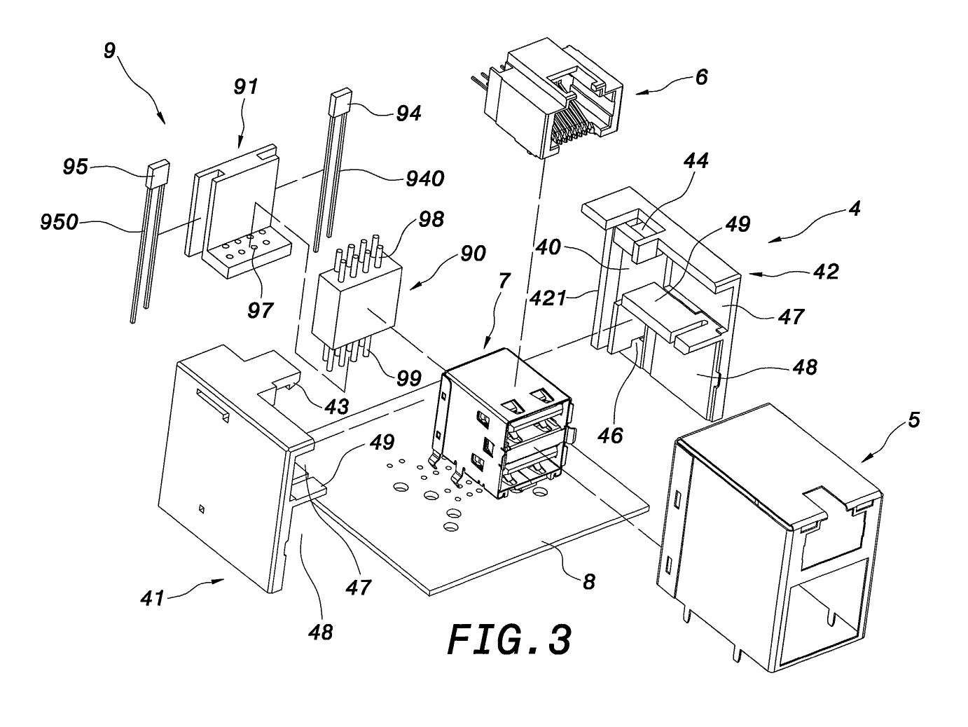

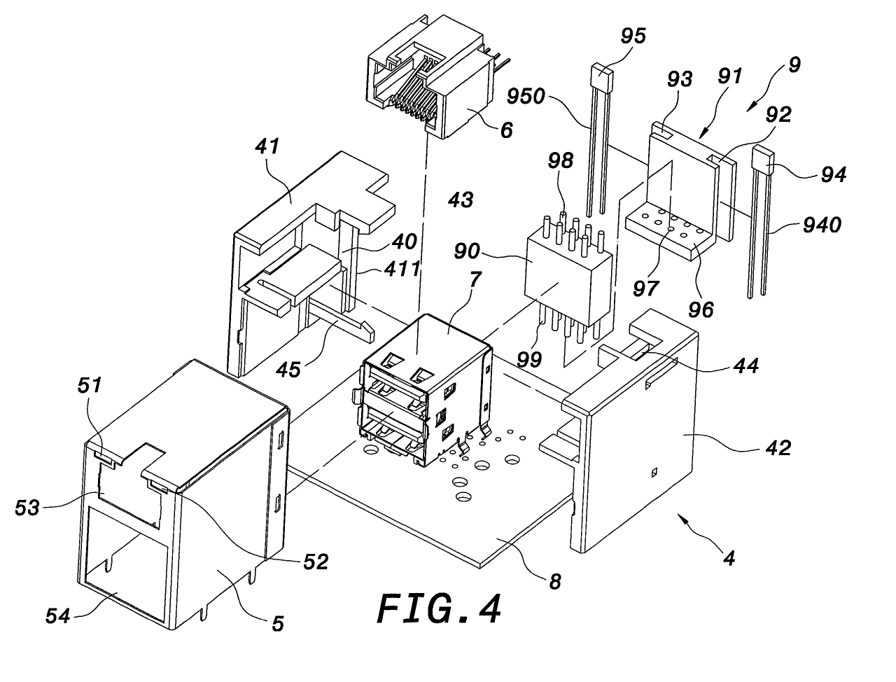

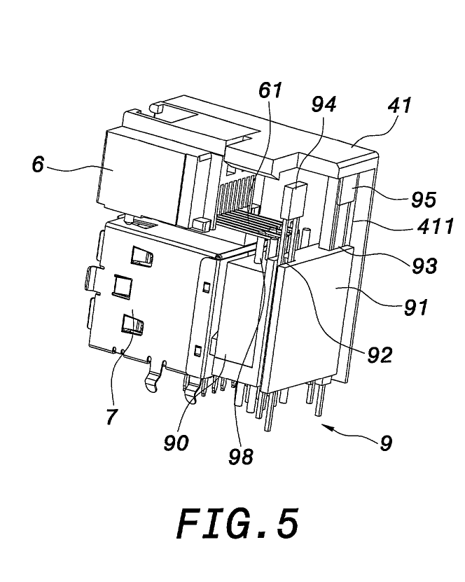

As shown in FIG. 2 through FIG. 5 illustrating an embodiment of the invention, the connector casing structure having light-guiding property of the invention comprises an internal casing 4 and an external casing 5. The external casing 5 encloses the internal casing 4 to prevent electromagnetic interference. The internal casing 4 is comprised of a left half body 41 and a right half body 42 that fixedly assemble with each other. To fixedly attach the left half body 4 with the right half body 42, the left half body 41 includes hook members 43, 45 that respectively engage into attachment slots 44, 46 provided on the right half body 42. More particularly, the hook member 43 is placed at an upper portion of the left half body 41, and the hook member 45 extends from an internal surface at a central portion of the left half body 41. The attachment slots 44, 46 are placed at locations of the right half body 42 corresponding to the hook members 43, 45 of the left half body 41. The left and right half bodies 41, 42 may be also fixedly attached to each other by adhesion. The internal casing 4 is made of light-guiding material. On a front side, a face of the internal casing 4 has a smooth surface that defines a transparent zone through which light can emanate while other remaining faces of the internal casing 4 have substantially opaque surfaces. On a front side, the external casing 5 is provided with upper and lower opening zones 53, 54, and left and right rectangular grooves 51, 52. Left and right rectangular grooves 51, 52 serve as light-emanating grooves through which lights of different colors can emanate.

Within an upper half of the internal casing 4 is defined an upper placement space 47 in which a first connector 6 is arranged. The first connector 6 is a standard signal connector that belongs to the category of eight pins RJ-type plug connectors. Within a lower half of the internal casing 4 is defined a lower placement space 48 separated from the upper placement space 47 via a plank 49. A second connector 7 is arranged in the lower placement space 48. The second connector 7 is an stacked-type Universal Serial Bus (USB) connector. Hence arranged, the USB connector directly connects an underlying circuit board 8 on which the external casing 5 is positioned.

A mounting space 40 is further defined within the internal casing 4 proximate to a rear side thereof to receive a guiding block 9 composed of a front guiding block 90 and a rear guiding block 91. Right and left sides of the rear guiding block 91 are further respectively provided with guiding slots 92, 93 through which connecting wires 940, 950 of light-emitting elements 94, 95 respectively insert. The light-emitting elements 94, 95 are light-emitting diodes (LED) each having two connecting wires 940. The connecting wires 940 of the light-emitting element 94 and the connecting wires 950 of the light-emitting element 95 respectively pass through the guiding slots 92, 93 to connect the circuit board 8. The left and right half bodies 41, 42 further internally bend into left and right bars 411, 421 that are vis-a-vis positioned. The left and right bars 411, 421 hence fit into the guiding slots 92, 93, to fixedly position the rear guiding block 91.

The rear guiding block 91 further has a plate 96 that extend forwardly. The plate 96 is provided with through holes 97. In accordance with a conventional arrangement, eight through holes 97 are distributed in two rows of four through holes placed in interleaving fashion. The front guiding block 90 is made of an insulating material, and partially encloses a plurality of protruding wires that extend upwardly and downwardly out of the front guiding block 90 into upper and lower portions 98, 99, respectively. The protruding wires within the front guiding block 90 are placed correspondingly to the through holes 97 of the rear guiding block 91. Thereby, with the rear guiding block 91 mounted on the circuit board 8, lower portions 99 can adequately pass through the corresponding through holes 97 of the rear guiding block 90 to electrically connect to the circuit board 8. Meanwhile, upper portions 98 of the protruding wires, in interleaving fashion, connect to terminal contacts 61 of the first connector 6 on a rear side of the first connector 6.

Hence achieved, the connector casing structure can guide light emitted from the light-emitting elements 94, 95 via the internal casing 4 to its front face, and thereby indicate whether the connection state is normal.

Those skilled in the art would readily understand that variations could be made to the above structure of the invention.

In a simpler embodiment of the invention, a light-guiding casing structure is substantially similar to the above structure except that it only encloses the signal connector 6 (upper portion of the structure shown in FIG. 2). Consequently, in the simpler embodiment, the internal casing, similarly fabricated from a light-guiding material, differs from the above structure by only having a single placement space that receives the signal connector. Instead of front and rear guiding blocks 90, 91, a single guiding block that may be similar to the rear guiding block 91 is arranged in a mounting space of the internal casing. Similar to the rear guiding block 91, the single guiding block has two guiding slots at two sides thereof to receive the connecting wires of a single light-emitting element. However, a plate 96 may be not necessary and the signal connector may be directly connected to the circuit board via specifically L-shaped terminal contacts that extend to connect to the circuit board. Nevertheless, front guiding block 90, rear guiding block 91 with extended plate 96, and protruding wires 98, 99 may be used to connect the terminal contacts of the singly enclosed signal connector to the circuit board in a manner similar to the above description. A single connector having a single luminous indicator is thereby achieved.

In conclusion, by including an internal casing that is light-guide and transparent, the characteristics of the connector casing structure of the invention substantially differ from those of the conventional connector casing structure. The connector casing structure of the invention does not necessitate the conventional light-guiding slot. Furthermore, in the invention, by using light-emitting elements of different colors and adequately matching the color of the internal casing half bodies with the color of the light-emitting elements, light guidance through the internal casing may be further improved. Moreover, unlike the conventional casing structure that necessitates specific designs of the connector terminal contacts and the light-emitting elements, the invention allows the light-emitting elements to be directly connected to the circuit board. Furthermore, the internal casing structure of the invention can be easily achieved, and only the front and rear guiding blocks need to be specific ally designed in accordance with the type of connector encased. The front and rear guiding blocks may be also fabricated into a single block to simplify assembly operations.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A connector casing structure having light-guiding property, comprising:
an internal casing having a left half body and a right half body being fixedly assembled with the left half body, the left and right half bodies each being fabricated from a light-guiding material; the internal casing having respectively an upper half where an upper placement space is defined to receive a first connector, and a lower half where is defined a lower placement space to receive a second connector; the internal casing further having a mounting space adjacent to a rear side thereof;
a rear guiding block fixedly arranged in the mounting space of the internal casing, the rear guiding block having two sides respectively formed with two guiding slots; at least a light-emitting element having a plurality of connecting wires that pass through each of the guiding slots; the rear guiding block having a plate further extended forwardly therefrom, the plate having a plurality of through holes therein; and
a front guiding block made of an insulating material, the front guiding block enclosing a plurality of protruding wires that extend upwardly and downwardly corresponding to the through holes of the plate of the rear guiding block.

2. The connector casing structure of claim 1, further comprising an external casing that substantially encloses the internal casing to prevent electromagnetic interference, wherein a front side of the external casing includes a plurality of rectangular grooves, and a plurality of openings that respectively correspond to the upper and lower placement spaces of the internal casing.

3. The connector casing structure of claim 1, wherein the internal casing has a front face formed with a smooth and transparent surface through which the light externally emanates, remaining faces thereof formed with substantially opaque surfaces.

4. The connector casing structure of claim 1, wherein the first connector is a signal connector received in the upper placement space.

5. The connector casing structure of claim 4, wherein the signal connector is of a RJ type.

6. The connector casing structure of claim 1, wherein the second connector is a Universal Serial Bus (USB) connector received in the lower placement space.

7. The connector casing structure of claim 6, wherein the USB connector is a stacked-type USB connector.

8. The connector casing structure of claim 1, wherein the light-emitting element is a light-emitting diode having two connecting wires.

9. The connector casing structure of claim 1, wherein the left half body and the right half body respectively have a plurality of bars each inserted in each of the guiding slots of the rear guiding block.

10. The connector casing structure of claim 1, wherein the left half body and the right half body are attached together by fastening or adhesion.

11. A connector casing structure having light-guiding property, comprising:
an internal casing fabricated from a light-guiding material, the internal casing defining a placement space therein to receive a connector, and a mounting space adjacent to a rear side thereof; and
a guiding block fixedly positioned in the mounting space of the is internal casing, the guiding block having two sides respectively formed with two guiding slots, at least a light-emitting element having a plurality of connecting wires that pass through each of the guiding slots.

12. The connector casing structure of claim 11, wherein the connector is a RJ-type signal connector.
